(19) United States
(12) Patent Application Publication
(10) Pub. No.: US 2009/0231439 A1
(43) Pub. Date: Sep. 17, 2009

(54) Method for Propagating Data Through a Video Stream

(76) Inventors: Arkady Kopansky, Havertown, PA (US); Yanjun Xu, Princeton, NJ (US); Jae-Beom Lee, Portland, OR (US); William Wei-lian Lin, East Windsor, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 12/404,043

(22) Filed: Mar. 13, 2009

Related U.S. Application Data
(60) Provisional application No. 61/036,621, filed on Mar. 14, 2008.

(51) Int. Cl. H04N 17/00

(52) U.S. Cl. 348/184; 348/E17.001

(57) ABSTRACT

A method for propagating an error between video frames of a video stream wherein data in a single macroblock is propagated from a first video frame to a second video frame via inter-frame coding. Once integrated into the second video frame, the macroblock may be utilized as the basis for intra-frame coding within the second video frame. Intra-frame coding within the second video frame allows for any error in the data contained in the macroblock to propagate through the second video frame while minimizing the amount of the second video frame dedicated to propagation the existing error(s). Embodiments of the present invention are directed to the application of stress to a decoder, to cause an error in the decoder, and propagation of the error between video frames of a video stream.

### CROSS-REFERENCE TO RELATED APPLICATION

This application claims the benefit of U.S. Provisional Application No. 60/036,621 filed on Mar. 14, 2008. The entire disclosure of U.S. Provisional Application No. 60/036,621 is incorporated by reference herein.

### FIELD OF THE INVENTION

The present invention relates to a method for testing the operation of a video decoder by propagating data between video frames of a video stream.

### BACKGROUND OF THE INVENTION

Compliance bitstreams are known in the art as a vehicle to test video decoders for compliance with standards, such as MPEG-2 and H.264/MPEG-4 AVC. Compliance bitstreams may be used to apply a stress to a given decoder and determine if the applied stress causes the decoder to generate an error.

Given the predictive nature of many video standards, a decoding error in an intra-coded video frame used for prediction by other video frames (i.e., reference frames) typically propagates from the intra-coded video frame to the related reference video frames. Unless special precautions are taken, a large area of the reference video frame is dedicated to propagating an error to subsequent video frames in the video frame sequence. In the event that a large area of a reference video frame is systematically utilized to propagate an error, only a small portion of the reference video frame remains for use to test decoder compliance.

During the testing process, decoders are challenged or stressed and as a result, may generate errors. For example, errors may be generated upon the application of excess stress or a particular type of stress to the decoder. Given that the application of stress, often large amounts of stress, is used to test the functionality of a decoder, it would be most beneficial to use the entire video frame area (or as large a part as possible) to effectively maximize the amount of stress applied to the decoder. Maximizing the amount of stress applied to a decoder may better test the functionality of a decoder, such as the decoder's computational ability or the ability to read/write data from various storage buffers. However, the desire to maximize the portion of a video frame dedicated to the application of stress is often in conflict with the use of a portion of a video frame utilized to propagate an error within a series of video frames.

In addition, certain conventional error propagation methods are designed solely for intra-frame coding and prohibit error propagation between video frames. For example, a video frame consisting solely of macroblocks utilizing intra-frame coding modes will, by design, prohibit error propagation between video frame since intra-coded video frames may be decoded using only the data within a given video frame. Given that data is not propagated between video frames when utilizing intra-frame coding, an error present in a first video frame does not propagate to a second video frame. Therefore, a stream with only intra-coded video frames does not propagate errors between and through the series of video frames in the video stream

Furthermore, under certain video encoding implementations, although errors may be generated and portions of a video frame may be propagated between video frames, the portion of the video frame containing the error may not be sampled for propagation. As a result the generated error may fail to propagate to subsequent video frames. FIG. 1 illustrates this problem within conventional decoders, wherein the use of existing inter-frame coding techniques prevents the propagation of a set of errors. In FIG. 1, the symbol “x” represents the occurrence of an error generated during the decoding of a given video frame. As illustrated in FIG. 1, extensive use of motion vectors and multi-reference access cause some errors not to propagate to the subsequent video frame or frames. For example, if the position corresponding to the error is not referenced during inter-frame coding, the error does not propagate to the following video frames. As illustrated in FIG. 1, the portion of the video frames selected from video frames 102-108 (i.e., the square regions within a given video frame) to be included in video frame 112 (i.e., the final video frame) does not contain any of the errors present in video frames 102-108. As a result, the errors generated in video frames 102-108 are not reflected in video frame 112, and as such, are not displayed to and detected by a viewer or by the automated test tools.

Therefore, there is a need in the art for a method for testing a video decoder which maximizes the usable portion of the video frames (i.e., the portion of the video frame used to carry content and/or stress during testing) of a video stream, while propagating any error in the decoded video stream such that an error, if present, may be detected.

### SUMMARY OF THE INVENTION

Embodiments of the present invention satisfy these needs and others by providing a method for facilitating data propagation between video frames while maximizing a portion of the video frame suitable for use in testing decoder functionality. In an embodiment of the present invention wherein the data contains an error, the error will be propagated between video frames. Embodiments of the present invention are directed to application of stress to a decoder, while allowing one or more errors to propagate between video frames of a video stream such that the one or more errors are visually represented via either a viewer or through automated testing tools to indicate a problem with the operation of the decoder.

Embodiments of the present invention provide for a method of propagating an error between video frames of a video stream, wherein data in a single macroblock is propagated from a first video frame to a second video frame via inter-frame coding modes. Once integrated into the second video frame, the macroblock is utilized as the basis for intra-frame coding within the second video frame. Intra-frame coding within the second video frame allows for any error contained in the macroblock to propagate through the second video frame to a subsequent video frame while minimizing the amount of the video frame utilized in the error propagation process. One having ordinary skill in the art will appreciate that the aforementioned process may be repeated to propagate a macroblock between subsequent video frames, up to and including a final video frame in the video stream. Embodiments of the present invention can be applied to any suitable video stream, including, for example, H.264 video streams or video streams utilizing predictive coding.

Embodiments of the present invention provide for a method of propagating an error from a first video frame to a second video frame, wherein a final row of macroblocks within the first video frame is propagated from the first video frame the second video frame. Given that any error generated during decoding results in the propagation of the error to at least a portion of the macroblocks contained in the final row of the video frame, propagating the final row of macroblocks from the first video frame to the second video frame ensures that any error present in the first video frame is propagated.

In certain embodiments of the present invention wherein a reference video frame is coded based on two video frames, such as a bidirectional video frame (B Frame), the two video frames from which the reference video frame depends provide only a portion of their respective final rows when propagating macroblocks to the reference video frame.

Embodiments of the present invention provide for a method of propagating data through a series of video frames and facilitating the display of a visual representation of the data, wherein the data may contain an error. The method includes the application of stress to a video frame decoder, wherein the stress affects the data located within a first video frame, and possibly causing an error within the data. Intra-frame coding is then used to propagate the data within the first video frame to a location of a last macroblock of the first video frame. The data is then propagated via inter-frame coding from the first video frame to a test video frame. Finally, the data is expanded within a test video frame to provide for better visual representation of the data.

Embodiments of the present invention further provide for bitstreams coded to provide error propagation wherein the errors are propagated between video frames a video stream, while maximizing the portion of the video frames directed at testing the functionality of the decoder. According to an embodiment of the present invention, a method is provided including bitstreams coded to provide single macroblock propagation or final row propagation.

### BRIEF DESCRIPTION OF THE DRAWINGS

The present invention will be more readily understood from the detailed description of exemplary embodiments presented below considered in conjunction with the attached drawings, of which:

FIG. 1 illustrates a prior art process of propagating data through a series of video frames of a video stream;

FIG. 2 illustrates an exemplary process for propagating data between video frames of a video stream, according to an embodiment of the present invention;

FIG. 3 illustrates an exemplary process for propagating data between video frames of a video stream through the use of inter-frame and intra-frame coding, according to an embodiment of the present invention;

FIG. 4 illustrates an exemplary process for propagating data through a series of video frames of a video stream, according to an embodiment of the present invention;

FIG. 5 illustrates an exemplary process for propagating data to bi-directional video frames; according to an embodiment of the present invention; and

FIG. 6 illustrates an exemplary process for generating a verification video frame; according to an embodiment of the present invention.

### DETAILED DESCRIPTION OF THE INVENTION

The present application relates to a method for propagating data between and through a series of video frames in a video stream in a manner which advantageously uses only a discrete or minimal portion of the respective video frame for potentially-corrupted data propagation. As a result, a larger portion of the video frame may be devoted to providing stress to a decoder in order to test the maximum capacity or capabilities of the decoder. As used herein, the term “stress” is intended to include, but is not limited to, any task that places a demand on the operation and functionality of a decoder. For example, according to certain embodiments of the present invention, stress may be used to test the computational abilities of the decoder or the decoder's ability to transfer data to or from a storage buffer. The applied stress may cause the decoder to produce an error. As a result of the application of stress, the decoder may affect change to the data that may be propagated through a series of video frames in the video stream. The resulting stress may cause the decoder to create an error within the data.

Given the interrelated nature of macroblocks within a video frame, data within a video frame may be propagated from any location within a video frame to the final macroblock within the video frame. The term ‘final macroblock’ is intended to include, but is not limited to, the last macroblock to be decoded within a given video frame. Utilizing predictive coding within a given video frame, the data within a macroblock is relied upon to generate subsequent macroblocks within a video frame. Given that the final macroblock in a video frame is often decoded last, the accuracy of the final macroblock is contingent upon properly decoding all preceding macroblocks. As a result, coding modes for the macroblocks within a video frame can be selected such that an error in decoding any of the macroblocks within a video frame is propagated to the final macroblock.

Embodiments of the present invention provide for a method of propagating data through a series of video frames and facilitating the display of a visual representation of the data, wherein the data may contain an error. The method includes the application of stress to a video frame decoder, wherein the stress affects the data located within a first video frame or any number of the following video frames, and possibly causing an error within the data. Intra-frame coding is then used to propagate the data within the first video frame to a location of a last macroblock of the first video frame. The data is then propagated via inter-frame coding from the first video frame to a second, third, and so forth, until it reaches a test video frame. Finally, the data is expanded within the last test video frame to provide for better visual representation of the data.

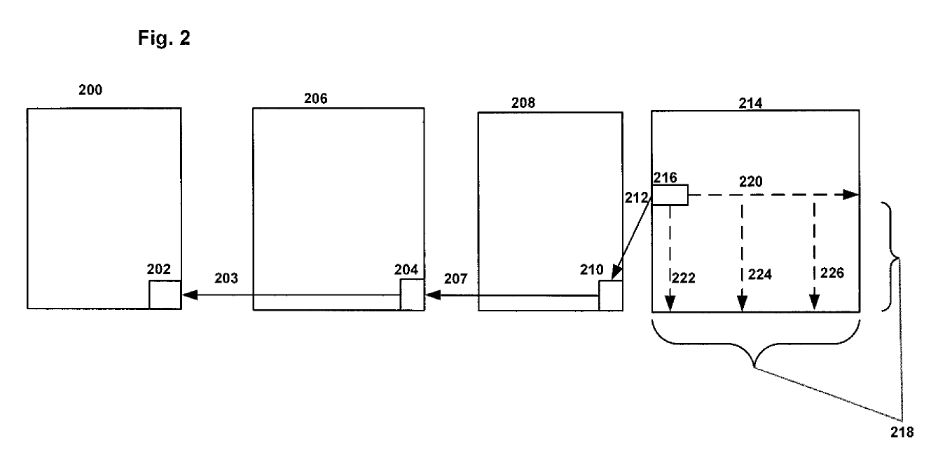

FIG. 2 illustrates an embodiment of the present invention wherein inter-frame coding is utilized to propagate data from a first video frame 200 to a second video frame 206 using only a single macroblock within each video frame. The embodiment of the present invention illustrated in FIG. 2 employs a single, motion vector 203 to propagate the data from macroblock 202 to a final macroblock 204 of a second video frame 206. This process is repeated in order to propagate the macroblock 204, via motion vector 207, to a final macroblock 210 in a third video frame 208. According to embodiments of the present invention, non-zero motion vectors, zero-valued motion vectors or a combination of the two may be used.

In an embodiment of the present invention, stress applied to a decoder while the decoder is processing the first video frame 200 cause a failure which produces an error within the first video frame 200. This error is propagated from within the first video frame 200 until it reaches the final macroblock 202 of the first video frame 200. As illustrated in FIG. 2, the data contained in the final macroblock 202 of the first video frame 200 is propagated via motion vector 203 to the final macroblock 204 within the second video frame 206. In an embodiment of the present invention wherein the data within the final macroblock 202 represents an error, the error is propagated from the first video frame 200 to the second video frame 206, and subsequently to the third video frame 208, as shown in FIG. 2. One having ordinary skill in the art will appreciate that any number of frames may be used to propagate the data and that three video frames followed by a final video frame is shown only for illustrative purposes.

FIG. 2 further illustrates the visual expansion of the data propagated through the first video frame 200, the second video frame 206, and the third video frame 208. As shown in FIG. 2, data in the final macroblock 210 of the third video frame 208 is propagated, via inter-frame coding with motion vector 212 from third video frame 208 to test video frame 214, wherein the macroblock 216 includes the propagated data including the error. Frames wherein an error is amplified may be referred to as a “test video frame.” The test video frame may be output to a display unit or to a device for automated analysis thereby better allowing for a determination of whether an error has occurred in the decoder. Through the use of horizontal intra-frame coding modes and vertical intra-frame coding modes, the error contained in macroblock 216 is expanded (i.e., the error is propagated to and through a plurality of macroblocks to increase the visual representation of the error in the test video frame 214) and made visually apparent in region 218. As illustrated in FIG. 2, macroblocks along the horizontal arrow 220 utilize one of the intra-frame coding modes to propagate the error data in macroblock 216 across the horizontal portion of test video frame 214. In conjunction with the macroblocks along the arrow 220, a series of macroblocks along the vertical arrows (222, 224, and 226), utilize one of the intra-frame coding modes to propagate data in macroblock 216 across a vertical portion of test video frame 214. Through the use of the macroblocks along the arrow 220 and arrows (222, 224, and 226), the error contained in macroblock 216 is disseminated over region 218. Therefore, a visual display of video frame 214 will include a visual representation of the error in region 218.

The use of a single macroblock (202, 204, 210) of each video frame of a video stream to propagate data between the first video frame 200, the second video frame 206, and the third video frame 208, minimizes the number of macroblocks within the respective video frames devoted to propagating data, while maximizing the number of macroblocks within the respective video frames available for the application of stress to the given decoder. Maximizing the number of available macroblocks for the application of stress allows for a compliance bitstream to better test a decoder's performance. Reserving a maximized portion of the video frame for the introduction of stress allows for the construction of compliance bitstreams that target a specific module (e.g., entropy decoder module, de-blocking module, motion compensation module, intra-frame prediction module, scaling and inversion transform module, and macroblock coder control module) or group of modules within a given decoder to isolate and determine which module is breaking down or failing to function properly.

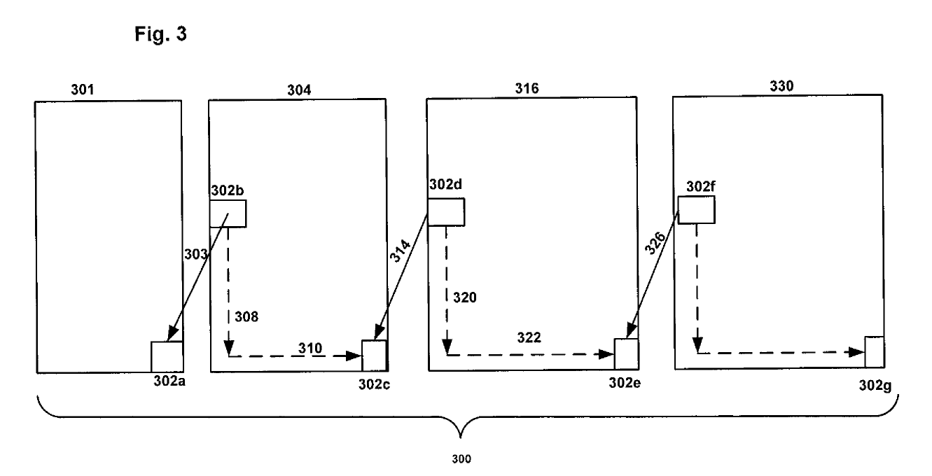

FIG. 3 illustrates an alternative embodiment of the present invention wherein both inter-frame coding and intra-frame coding are utilized to propagate data between a series of video frames. FIG. 3 illustrates an exemplary process for propagating the data between video frames (301, 304, 316, 330) of a video stream 300. In FIG. 3, inter-frame coding 303 is used to propagate data within a macroblock 302a of a first video frame 301 to a second video frame 304. In the embodiment of the present invention illustrated in FIG. 3, the data contained in macroblock 302a may included an error, wherein the relationship between macroblocks 302a-302g enable the error to propagate though video frames 301, 304, 316 and 330. Macroblock 302b in second video frame 304 is inter-frame coded, wherein a motion vector 303 is used to reference macroblock 302a. Following inter-frame coding via motion vector 303, intra-frame coding is utilized within second video frame 304 to propagate the data within macroblock 302b to final macroblock 303c. Intra-frame coding within second video frame 304 is facilitated via intra-frame coding along vertical arrow 308 and horizontal arrow 310. Macroblocks using a vertical intra-frame prediction coding mode, such as, for example, Intra_{—}4×4_Vertical, along arrow 308 and a horizontal intra-frame prediction coding mode, such as, for example, Intra_{—}4×4_Horizontal, along the arrow 310, propagate the data in macroblock 302b to macroblock 302c, the final macroblock in the second video frame 304. It should be noted that other intra-frame coding prediction modes may be utilized to propagate the error within a given video frame, including but not limited to, Intra_{—}4×4_Vertical, Intra_{—}8×8_Vertical, Intra_{—}16×16_Vertical, Intra_{—}4×4_Horizontal, Intra_{—}8×8_Horizontal, or, Intra_{—}16×16_Horizontal. In alternative embodiments of the present invention, diagonal intra-frame coding modes may be used to propagate data for macroblocks within a given video frame.

As shown in FIG. 3, data in macroblock 302c is used as a reference, via motion vector 314, for inter-frame coded macroblock 302d from third video frame 316 to second video frame 304. As a result, the error, if any, is propagated from second video frame 304 to third video frame 316. The error information captured by macroblock 302c is propagated by motion vector 314 via inter-frame coding to macroblock 302d included in third video frame 316. The error information is then propagated within third video frame 316 through intra-frame coding to macroblock 302e. Macroblocks using one of the vertical intra-frame prediction coding modes, along the arrow 320 and one of the horizontal intra-frame prediction coding modes, along the arrow 322 will propagate the contained in macroblock 302d to macroblock 302e, the final macroblock in the third video frame 316. This process of inter-frame and intra-frame coding is utilized to propagate the data in macroblock 302e to macroblock 303f, and ultimately to macroblock 302g.

In contrast to the embodiment of the present invention illustrated in FIG. 2 wherein only a single macroblock is used to propagate data including an error between video frames, FIG. 3 illustrates an embodiment of the present invention wherein the propagated error utilizes a limited portion of a frame to propagate the error. The use of a limited portion of a video frame to propagate error provides a larger identifiable visual representation of the error within the video frame compared to an embodiment of the present invention wherein only a single macroblock is utilized. As a result, the embodiment of the present invention illustrated in FIG. 3 still provides for a substantial portion of the video frame to be used for the application of stress, while also providing for an enhanced visualization representation of the target data.

Certain precautions may be taken in order to prevent conventional error concealment tools of a given decoder from concealing errors that are desirably detected in a testing environment. For example, the originally coded pixel values in the bottom row of macroblocks, the last macroblock (e.g., macroblocks 302a, 302c, 302e), or other portion of a frame utilized for error propagation may be varied from frame-to-frame. According to an embodiment of the present invention, pixel values are altered frame-to-frame to counteract the error concealment technique of copying the related pixel value from a previously decoded frame in order to conceal an error. In addition, values of 0 or 255 might not be used for the 8-bit source video to prevent clipping from attenuating the error during propagation or eliminating the error entirely. The use of clipping wherein the pixel value of the last macroblock is 0 or 255 may result in undesired error concealment.

The range of the motion vectors used for inter-frame coding may be changed and thus determine or restrict the position of the macroblock propagated via inter-frame coding. This range may be dictated by the selected profile and level of the given motion vector. Certain embodiments of the present invention include the propagation of the data in a macroblock via inter-frame coding wherein the macroblock to be propagated is not the final macroblock. For example, it may be placed close to the middle of a video frame to enhance error visibility such that if a decoded video frame is displayed on a monitor with an overscan, the macroblock is still visible.

In certain embodiments of the present invention it may be desirable to expand the visual representation of the data, when displayed, thereby making the data more visually apparent. This expansion may occur after the application of stress to the decoder. Following a series of video frames designed to applied stress to the decoder, a test video frame may be used to expand the propagated data, thereby making the any error within the data more visually apparent.

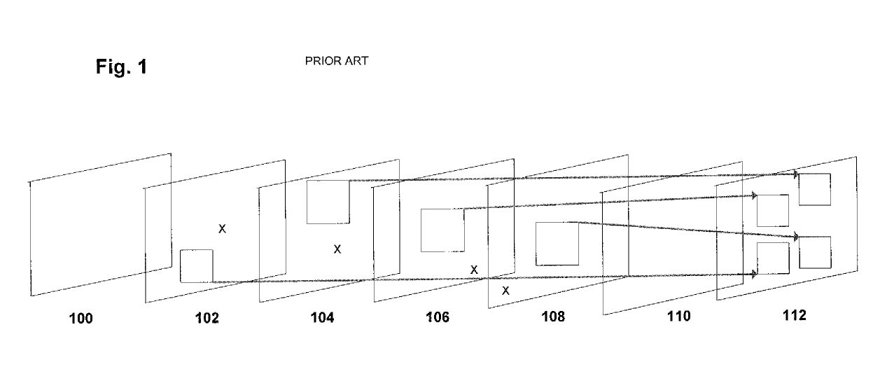

In certain embodiments of the present invention, application of high levels of stress may cause a decoder to run out of time while decoding a given video frame, and as a result all macroblocks that are decoded after the allotted time expires also contain an error. Accordingly, macroblocks in the bottom row of a video frame are most likely to contain errors, if corruption has occurred. Therefore, the bottom row or last row of a video frame is an optimal portion of the video frame to utilize for the propagation of one or more errors during inter-frame coding. Unlike FIG. 1 where different and random portions of video frame 102-108 are sampled, embodiments of the present invention employ targeted sampling of the final portion of a series of video frames to increase the likelihood of propagating an error.

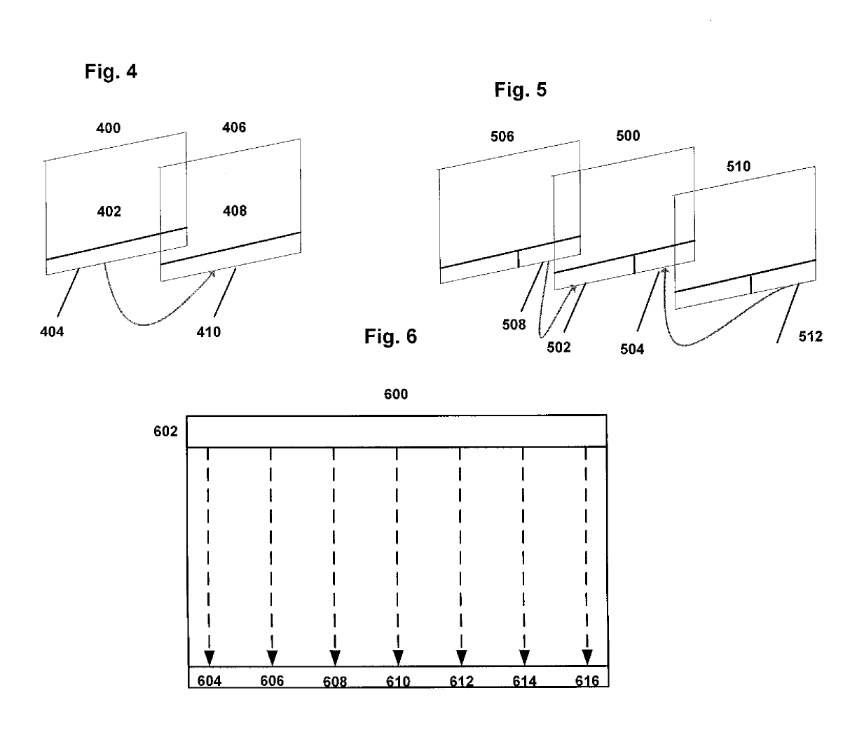

FIG. 4 illustrates a method according to an embodiment of the present invention wherein inter-frame coding is used to propagate the data in the final row of macroblocks through a series of video frames. The series of video frames contain an intra-coded video frame (I Frame) followed by a series of predictive, or inter-coded video frames (P Frames). As described above, errors caused by high stress are typically present in the final row of macroblocks. As a result, propagating the data in the final row of macroblocks between video frames is an effective method for propagating any existing errors through the series of video frames.

As illustrated in the embodiment of the present invention shown in FIG. 4, the video frame 400 is an I Frame to which video flame 406 refers. Given that the macroblocks contained in the final row of a video frame are the most likely macroblocks to contain errors, the data in the final row 404 of the video frame 400 is propagated via inter-frame coding to video frame 406 in order to propagate any existing errors. Utilizing only the final row of macroblocks allows for the remaining portion 402 of video frame 400 to be utilized for applying stress to the decoder. Once propagated from video frame 400, the final row of macroblocks 404 is integrated into video frame 406 as the final row of macroblocks 410 in video frame 406. The process described in FIG. 4 provides for propagating the data in the final row of macroblocks from each video frame to achieve propagation of errors within the video frame to the subsequent video frames.

FIG. 5 illustrates a variation on the process described in FIG. 4, wherein the final row of macroblocks is utilized to propagate data in macroblocks from two video frames into one video frame. As shown in FIG. 5, a B frame 500 is included in the bitstream. Given that B frame 500 utilizes portions of both the prior video frame (i.e., frame 506) as well as the subsequent video frame (i.e., frame 510) for prediction, the process illustrated in FIG. 5 splits the final row of macroblocks into two segments (first portion 502 and second portion 504). As illustrated in FIG. 5, the first portion 502 of the final row of B Frame 500 uses a portion 508 of I Frame 506 for reference, while a second portion 504 uses a portion 512 of P Frame 510 for reference. Accordingly, the data in the last half of the final row of macroblocks of video frames 506 and 510 are propagated to video frame 500. As described above, utilizing the final macroblocks of a given video frame to propagate an error increases the likelihood that the portion of the video frame that is propagated contains any error that is present within the video frame.

Following the propagation of data through a series of video frames, expansion of the data within a test video frame may by used to allow expanded visual representation of the data on a display, thereby allowing for easier detection of error. As shown in the embodiments of the present invention illustrated in FIG. 6, all macroblocks in the final video frame can reference the final row of macroblocks in the previous video frame to increase the visibility of any errors that may be present. As illustrated in FIG. 6, test frame 600 utilizes the last row of the previous video frame as its first row 602. In addition, macroblocks along the arrows 604-616 propagate any errors within the first row of macroblocks 602 through video frame 600. As a result, as error contained in the first row 602 is amplified and spread throughout the test video frame 600.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

1. A method for propagating data through a series of video frames and facilitating display of the data, comprising the steps of:
applying a stress to a video frame decoder, wherein the stress affects the data located within a first video frame;
propagating the data located in a last macroblock of the first video frame via inter-frame coding from the first video frame to a test video frame; and
facilitating the display of a visual representation of the data within the test video frame.

2. The method of claim 1, further comprising the step of utilizing intra-frame coding to propagate the data within the first frame to the location of the last macroblock of the first video frame.

3. The method of claim 1, wherein the step of propagating the data located at the last macroblock within the first frame via inter-frame coding includes propagating the data to a location of a last macroblock of the test second frame.

4. The method of claim 1, further comprising the step of expanding the visual representation of the data within the test video frame.

5. The method of claim 4, wherein the step of expanding the visual representation of the data within the test video frame includes propagating the data via intra-frame coding within the test video frame.

6. The method of claim 4, wherein the step of expanding the visual representation of the data within the test video frame includes propagating the data via vertical intra-frame coding within the test video frame.

7. The method of claim 4, wherein the step of expanding the visual representation of the data within the test video frame includes propagating the data via horizontal intra-frame coding within the test video frame.

8. The method of claim 1, wherein the data comprises an error.

9. The method of claim 1, wherein the series of video frames are encoded pursuant the H.264 standard.

10. The method of claim 1, wherein the data represents a pixel value in the range of 1 to 254.

11. A method for propagating data through a series of video frames and facilitating display of the data, comprising the steps of:
applying a stress to a video frame decoder, wherein the stress affects the data located within a first video frame;
propagating the data located in a last macroblock of the first video frame via inter-frame coding from the first video frame to a second video frame;
propagating the data via vertical intra-frame coding to a final row of macroblocks of the second video frame;
propagating the data via horizontal intra-frame coding to a final macroblock of the second video frame;
propagating the data located at the last macroblock of the second video frame via inter-frame coding from the second video frame to a test video frame; and
facilitating the display of a visual representation of the data within the test video frame.

12. The method of claim 11, further comprising the step of utilizing intra-frame coding to propagate the data within the first video frame to the location of the last macroblock of the first video frame.

13. The method of claim 11, wherein the step of propagating the data located at the last macroblock within the second frame via inter-frame coding includes propagating the data to a location of a last macroblock of the second video frame.

14. The method of claim 11, further comprising the step of expanding the visual representation of the data within the test video frame.

15. The method of claim 14, wherein the step of expanding the visual representation of the data within the test video frame includes propagating the data via intra-frame coding within the test video frame.

16. The method of claim 14, wherein the step of expanding the visual representation of the data within the test video frame includes propagating the data via vertical intra-frame coding within the test video frame.

17. The method of claim 14, wherein the step of expanding the visual representation of the data within the test video frame includes propagating the data via horizontal intra-frame coding within the test video frame.

18. The method of claim 11, wherein the data comprising an error.

19. The method of claim 11, wherein the series of video frames are encoded pursuant the H.264 standard.

20. The method of claim 11, wherein the data represents a pixel value in a range of 1 to 254.

21. The method of claim 11, wherein the last macroblock of the first frame and the last macroblock of the second video frame are originally assigned different pixel values.

22. A computer-readable storage medium storing computer code for implementing a method for propagating data through a series of video frames and facilitating display of the data, wherein the computer code comprises:
code for applying a stress to a video frame decoder, wherein the stress affects the data located within a first video frame;
code for propagating the data located in a last macroblock via inter-frame coding from the first video frame to a second video frame; and
code for facilitating the display of a test video frame thereby providing for a visual representation of the data.

23. The computer-readable storage medium of claim 22 further comprising code for utilizing intra-frame coding to propagate the data within the first frame to a location of a last macroblock of the first video frame.

24. The computer-readable storage medium of claim 22, wherein the code for propagating the data located at the last macroblock of the first video frame via inter-frame coding includes code for propagating the data to a location of a last macroblock of the second video frame.

25. The computer-readable storage medium of claim 22 further comprising code for expanding the visual representation of the data within the test video frame.

26. The computer-readable storage medium of claim 22, wherein the code for expanding the visual representation of the data within the test video frame includes code for propagating the data via intra-frame coding within the test video frame.

27. The computer-readable storage medium of claim 26, wherein the code for expanding the visual representation of the data within the test video frame includes code for propagating the data via vertical intra-frame coding within the test video frame.

28. The computer-readable storage medium of claim 26, wherein the code for expanding the visual representation of the data within the test video frame includes code for propagating the data via horizontal intra-frame coding within the test video frame.

29. The computer-readable storage medium of claim 26, wherein the data comprises an error.

30. The computer-readable storage medium of claim 22, wherein the series of video frames are encoded pursuant the H.264 standard.

31. The computer-readable storage medium of claim 22, wherein the data represents a pixel value in a range of 1 to 254.

32. A computer-readable storage medium storing computer code for implementing, a method for propagating data through a series of video frames and facilitating display of the data, wherein the computer code comprises:
code for applying a stress to a video frame decoder, wherein the stress affects the data located within a first video frame;
code for propagating the data located in a last macroblock of the first video frame via inter-frame coding from the first video frame to a second video frame;
code for propagating the data via vertical intra-frame coding to a final row of macroblocks of the second video frame;
code for propagating the data via horizontal intra-frame coding to a final macroblock of the second video frame;
code for propagating the data located in the last macroblock of the second video frame via inter-frame coding from the second video frame to a test video frame; and
code for facilitating the display of a visual representation of the data within the test video frame.

33. The computer-readable storage medium of claim 32 further comprising code for utilizing intra-frame coding to propagate the data within the first frame to the location of the last macroblock of the first video frame.

34. The computer-readable storage medium of claim 32 wherein the code for propagating the data located at the last macroblock within the first video frame via inter-frame coding includes code for propagating the data to a location of a last macroblock of the second video frame.

35. The computer-readable storage medium of claim 32 further comprising code for expanding the visual representation of the data within the test video frame.

36. The computer-readable storage medium of claim 35, wherein the code for expanding the visual representation of the data within the test video frame includes code for propagating the data via intra-frame coding within the test video frame.

37. The computer-readable storage medium of claim 35, wherein the code for expanding the visual representation of the data within the test video frame includes code for propagating the data via vertical intra-frame coding within the test video frame.

38. The computer-readable storage medium of claim 35, wherein the code for expanding the visual representation of the data within the test video frame includes code for propagating the data via horizontal intra-frame coding within the test video frame.

39. The computer-readable storage medium of claim 32, wherein the data comprises an error.

40. The computer-readable storage medium of claim 32, wherein the series of video frames are encoded pursuant the H.264 standard.

41. The computer-readable storage medium of claim 32, wherein the data represents a pixel value in a range of 1 to 254.

42. The computer-readable storage medium of claim 32 wherein the last macroblock of the first video frame and the last macroblock of the second video frame are originally assigned different pixel values.
